(19) United States
(12) Patent Application Publication
(10) Pub. No.: US 2008/0093098 A1
(43) Pub. Date: Apr. 24, 2008

(54) ELECTRICAL STRINGER OUTLET BOX

(75) Inventor: Joel Golbin, Sherman Oaks, CA (US)

Correspondence Address: SNELL & WILMER L.L.P. (Main), 400 EAST VAN BUREN, ONE ARIZONA CENTER, PHOENIX, AZ, 85004-2202, US

(73) Assignee: THE VIAD CORPORATION, Phoenix, AZ (US)

(21) Appl. No.: 11/552,432

(22) Filed: Oct. 24, 2006

(51) Int. Cl. H02G 3/08

(52) U.S. Cl. 174/50

(57) ABSTRACT

An electrical stringer box for enclosing electrical junctions, the stringer box including a base plate and housing providing lowered cable positioning and secure cable retention through cable collars defining ribbed recesses at a lower edge of the stringer box housing. Screw guides at the corners of the housing provide for attachment of the housing to the base plate. A moveable top plate provides convenient access to the housing interior. A low-cost stringer box of varied configurations is producible from a common injection mold using moveable outlet opening image inserts to selectively form outlet receptacle openings on different faces or sidewalls of the stringer box.

### FIELD OF INVENTION

This invention generally relates to enclosures for electrical connections and more particularly to stringer boxes and outlet boxes.

### BACKGROUND OF THE INVENTION

Stringer boxes are commonly used to enclose line-splices and end-splices in lengths of electrical cabling. For example, in the context of a trade show or convention, event staff lay lengths of electrical cabling and install outlet receptacles at various points along the cable lengths to distribute power to the display booths. In some instances, outlet receptacles are installed at the ends of separate cable lengths spliced into a main cable. In other instances, a series of electrical outlets may be spliced directly along the main cable and housed within a corresponding series of stringer boxes.

Some common stringer boxes only accommodate end-splices as the ends of the various wires must be passed through holes in the sidewalls of the stringer box. Various other devices have been proposed to accommodate line-splices along a continuous cable. For example, various known stringer box designs are separable into multiple symmetrical sections that are combinable over a continuous cable. A stringer box may have solid sidewalls forming a sealed enclosure around an electrical junction, or may include openings in a sidewall to support a conventional dual-outlet receptacle within the stringer box.

In the case of plastic constructions, separate molds are typically required to form stringer boxes having different shapes or number of outlet openings or cable openings. The expense of separate molds and the time required to change molds adds to the cost of the different configurations. Thus, there is a need for a more cost effective process for producing stringer boxes of varied configurations.

The cable openings on known stringer boxes are commonly located along an axis of symmetry of the stringer box above the plane of the floor causing the cable to rise from the floor as it approaches the cable opening. Elevated cables present a tripping hazard and may also lead to damage of the cable or stringer box if the cable is stepped upon or is caught by heavy objects. For example, if a heavy moving object catches a cable between two stringer boxes, the cable may be pulled partially or completely from one of the stringer boxes, compromising the electrical connections housed within the stringer box.

Various known cable retainer or cable collar designs have been proposed to retain the cable within the stringer box. One common design provides a clamp associated with a cable collar formed on the stringer box and fasteners to tighten the clamp against the sheath of the cable. Additional clamp fasteners, however, require additional setup and tear down time, which can be a significant inefficiency for large electrical networks that are repeatedly reconfigured, as is the case with convention centers.

Accordingly, a need exists for a stringer box providing for lowered cable positioning, reduced manufacturing cost and increased set-up efficiency.

### SUMMARY OF THE INVENTION

While the way that the present invention addresses the disadvantages of the prior art will be discussed in greater detail below, in general, the present invention provides for lowered cable positioning and secure cable retention within a variety of low-cost stringer boxes producible from a common injection mold.

An exemplary stringer box includes a rectangular base plate with ribbed recesses at opposite ends thereof and an inverted housing mountable to the base plate and having complementary ribbed recessed aligned with the recesses in the base plate. The walls of the housing may be formed with solid faces or with outlet receptacle openings on a number of housing faces depending on the use of removable opening image inserts during the injection molding process.

An exemplary stringer box further comprises recessed screw guides on the housing corners aligned with holes in the base plate for securing the housing to the base plate. In alternative embodiments, the housing may include a moveable or removable top plate or side wall providing convenient access to the housing interior without releasing the cable. The top plate and any number of side walls may have a solid face or may include outlet receptacle openings.

In an exemplary method of producing a variety of stringer box configurations from a common mold, a first solid-faced housing is injection molded in the common mold. An outlet opening image insert is then placed within the mold to form a second housing configuration having outlet receptacle openings formed in a sidewall thereof. The first image insert or a second image insert is then placed on a second sidewall of the mold to produce a third housing configuration having outlet receptacle openings formed in a second sidewall thereof.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures, and

FIG. 1 illustrates a perspective view of an exemplary stringer box according to one embodiment having solid faces;

FIG. 2 illustrates a perspective view of an exemplary stringer box according to a second embodiment having outlet receptacle openings formed in a sidewall thereof;

FIG. 3 illustrates a perspective view of an exemplary stringer box base plate according to one embodiment; and

FIG. 4 illustrates a perspective view of an exemplary end cap for used with a stringer box according to one embodiment.

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, and the like and still fall within the scope of the present invention. Thus, the detailed description herein is presented for purposes of illustration only and not of limitation.

In accordance with various aspects of the present invention, a stringer box is a housing or closure used to enclose an electrical junction, such as an end-splice or a line-splice connecting separate lengths of electrical cable or connecting outlets to a main cable. In addition, a stringer box may carry various electrical outlet receptacles. Accordingly, a stringer box may have solid faces or may have openings formed therein for receiving various standard outlet receptacles.

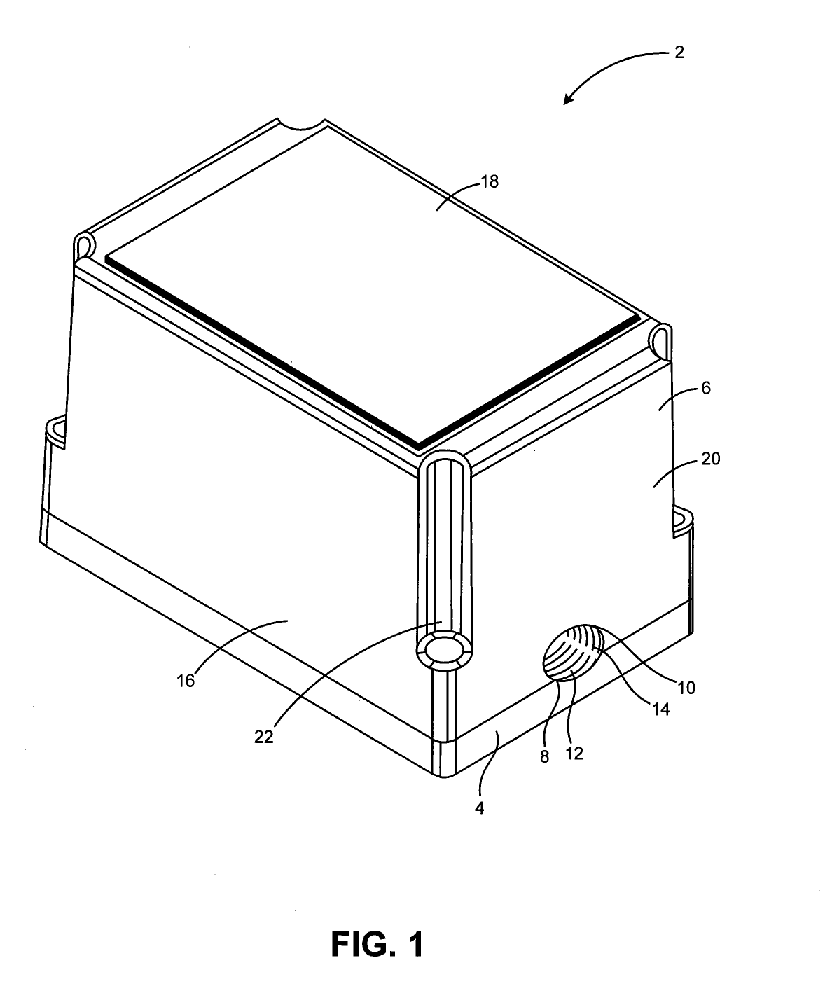

With reference now to FIG. 1, an exemplary stringer box 2 according to one embodiment of the present invention includes a base plate 4 and housing 6 having complementary recesses 8 and 10 formed respectively therein along the interface between base plate 4 and housing 6. Complementary recesses 8 and 10 are configured to receive a sheathed electrical cable. Recesses 8 and 10 respectively carry projections 12 and 14 configured to partially embed in or otherwise grip the sheath of the electrical cable to secure the cable within stringer box 2. For example, the bottom surface of base plate 4 may be positioned on the floor and an electrical cable and/or electrical junction placed on the top surface of base plate 4 aligned with recess 8. Housing 6 is then placed over the electrical cable and/or electrical junction with recess 10 aligned with the cable and recess 8. The diameter of the cable is preferably greater than the opening between projections 12 and 14 such that projections 12 and 14 grip the cable to securely retain the cable in stringer box 2.

In a preferred embodiment, recesses 8 and 10 define an opening having a diameter generally corresponding to the diameter of a cable to be secured therein and extending to within a distance of the bottom of base plate 4 substantially equal to twice the diameter of the opening defined by recesses 8 and 10. In a preferred embodiment, the opening defined by recesses 8 and 10 is positioned within a distance of the bottom of base plate 4 substantially equal to diameter of the opening. Thus, a cable may be secured to stringer box 2 approximately within a cable's diameter of the floor, increasing the safety of the design and reducing the likelihood of damage to the cable.

Housing 6 further includes sidewalls 16, top plate 18, end walls 20 and screw guides 22, which may be injection molded as an integral unit. Alternative configurations may be made using removable inserts adjacent the mold sections corresponding to sidewalls 16, top plate 18, or end walls 20. For example, outlet openings may be formed in any of sidewalls 16, top plate 18, or end walls 20 by insertion of an outlet opening image insert prior to injection molding. Alternatively, any one of sidewalls 16, top plate 18 or end walls 20 may be formed separately and attached to housing 6 so as to be moveable or removable to provide convenient access to the interior of housing 6. Housing 6 and base plate 4 may be injection molded or otherwise formed from plastic, may be cast from aluminum or iron, or may otherwise be formed from any suitable material by any process now known or later developed.

Any of sidewalls 16, top plate 18 or end walls 20 may further include reinforcing features such as supporting ribs or thickened edges to harden housing 6 against the rigors of use and exposure. For example, the portions of base plate 4 and/or housing 6 carrying recesses 8 and 10 may be thickened or extended inward or outward to provide sufficient surface area and number of projections to adequately secure the cable. Accordingly, housing 6 and/or base plate 4 may include a cable collar extending outward or inward from end walls 20.

Screw guides 22 are formed at the corners defined by the intersection of sidewalls 16 and end walls 20 and include holes aligned with corresponding holes on base plate 4 for attachment of housing 6 to base plate 4. Screw guides 22 may receive a screw fastener inserted first through base plate 4 or may inversely receive a fastener which then engages base plate 4. The fastener may alternatively be used to secure housing 6 and base plate 4 to the floor. Any number of the holes in base plate 4 may optionally be through holes to facilitate attachment of housing 6 to base plate 4.

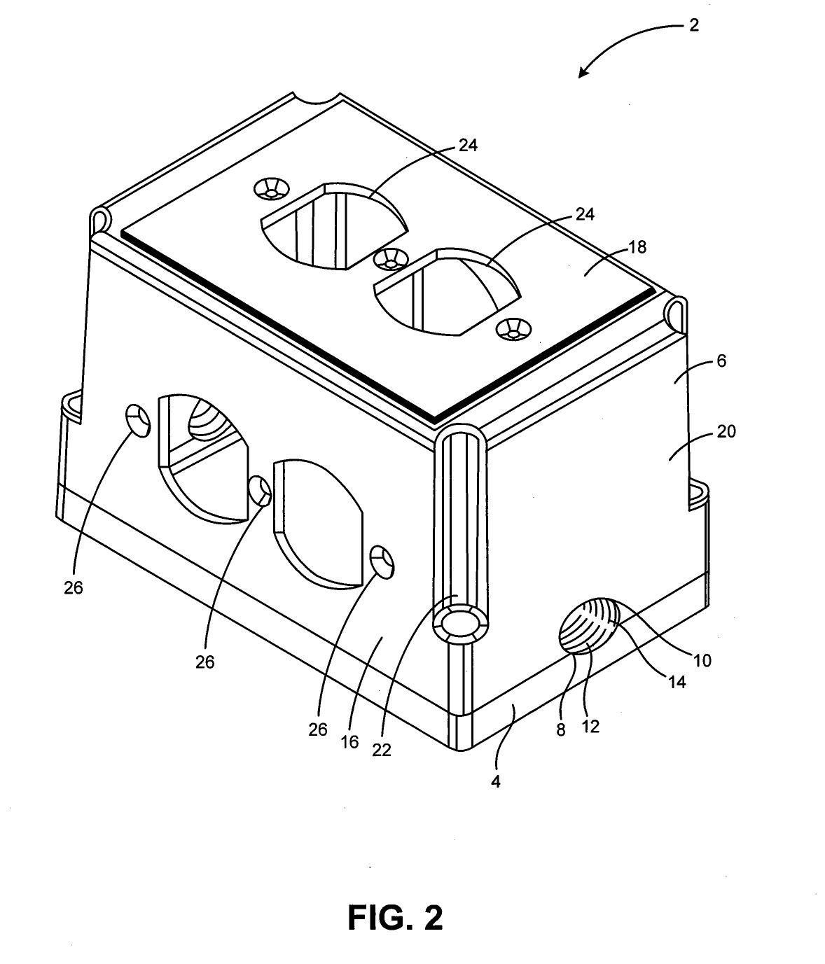

With reference to FIG. 2, a second exemplary stringer box 2 is shown according to another embodiment of the present invention in which top plate 18 and one or more of sidewalls 16 include outlet receptacle openings 24 and outlet fastener openings 26 for supporting electrical outlet receptacles within housing 6. For example, fastener openings 26 may be used to secure an outlet receptacle at either end and/or in the middle of the receptacle. While outlet receptacle openings 24 are shown here in the context of the common dual outlet design, it is understood that outlet receptacle openings 24 may be of any number, shape, or size to accommodate a selected electrical outlet receptacle. Similarly, fastener openings 26 may be of any number, shape, or size as needed to secure an outlet receptacle to housing 6. Alternatively, an outlet receptacle may be secured to housing 6 with a hidden fastener without the need for through holes in sidewalls 16 or top plate 18.

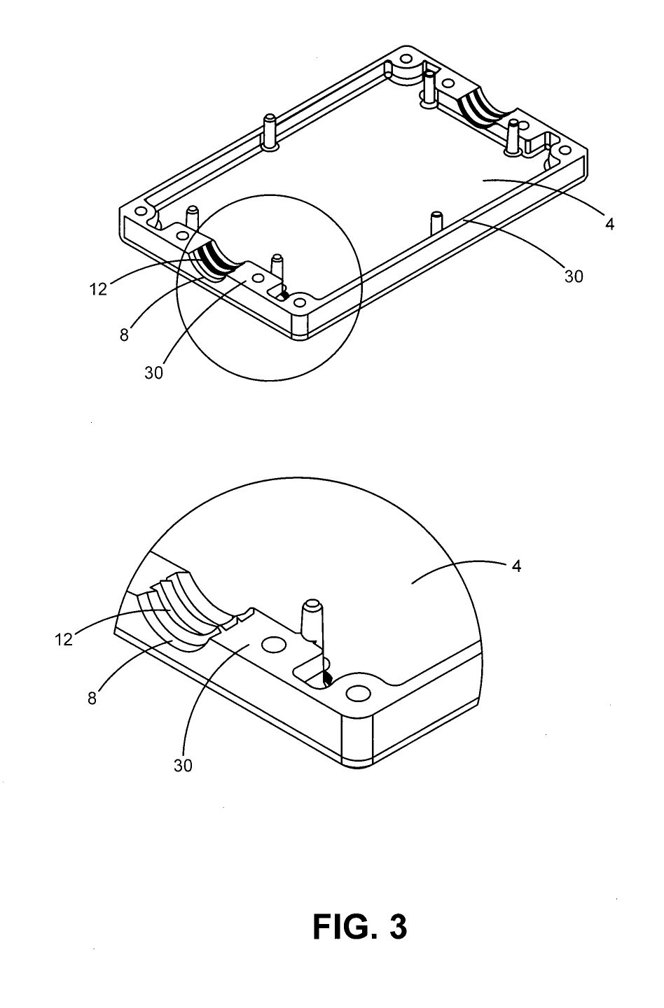

With reference to FIG. 3, an exemplary base plate 4 is shown having a raised upwardly extending rim 30 around the periphery of base plate 4. As discussed above, rim 30 may be thicker adjacent recess 8 to be coextensive with the portion of end wall 20 and/or a cable collar carrying recess 10. Rim 30 may be aligned under sidewalls 16 and end walls 20 of housing 6 or may be configured to fit within and/or without sidewalls 16 or end walls 20 of housing 6. Various embodiments may include a seal along rim 30 between base plate 4 and housing 6.

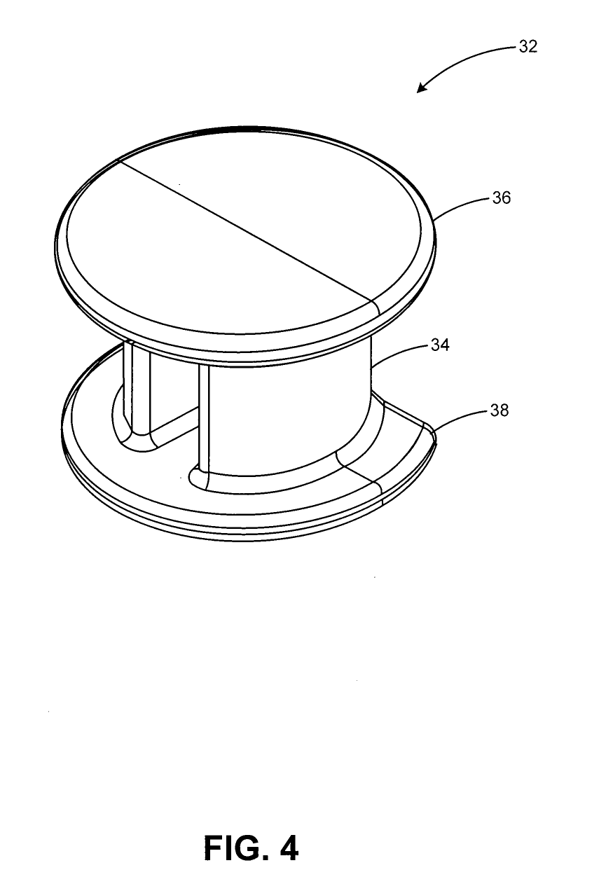

With reference to FIG. 4, an end cap 32 may be used to plug complementary recesses 8 and 10 when not in use. End cap 32 includes a central cylindrical section 34 and flanges 36 and 38 at the ends of cylindrical section 34 to retain end cap 32 in complementary recesses 8 and 10. Flange 36 may circumscribe complementary recesses 8 and 10 external to stringer box 2 while flange 38 may be configured to extend past only a portion of complementary recesses 8 and 10 inside stringer box 2. Alternatively or additionally, cylindrical section 34 may be formed of a resilient material or may include projections to be engaged by projections 12 and 14, obviating retaining flanges 36 and 38. It is understood that any configuration of end cap 32 may be used to suitably close off an unused opening formed by complementary recesses 8 and 10, for example when stringer box 2 is used simply as an outlet box at the end of a cable such that the second opening is not needed.

Various alternative embodiments of stringer box 2 may include optional features such an LED for indicating when a cable is live, and moveable covers over unused outlet receptacles, or retainers for securing a power cord inserted into an outlet receptacle. Any other device associated with electrical junctions and electrical outlets that is now known or later developed may be used with stringer box 2.

In an exemplary method of producing various configurations of stringer box 2 from a common mold, a first solid-faced configuration of housing 6 is injection molded in the common mold. An outlet opening image insert is then placed adjacent a mold sidewall to form a second configuration of housing 6 having receptacle openings 24 formed in one of sidewalls 16. The first image insert or a second image insert is then placed adjacent a second sidewall of the mold to produce a third configuration of housing 6 having receptacle openings 24 formed in a second of sidewalls 16.

Finally, while the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. An electrical stringer box providing low cable positioning, said stringer box comprising:
a base plate having a top surface and a bottom surface, said base plate carrying a first recess at an edge of said top surface;
a housing attachable to said base plate and having a complementary second recess alignable with said first recess formed in said base plate, at least one of said first and second recesses carrying a projection configured to retain an electrical cable, said first and second recesses defining an opening for receiving said electrical cable, said opening having a diameter and being positioned within a distance of said bottom surface generally equal to twice said diameter.

2. The stringer box of claim 1, wherein said housing comprises four contiguous sidewalls and a plurality of screw guides formed at a plurality of edges of said housing, said plurality of screw guides configured to facilitate attachment of said housing to said base plate.

3. The stringer box of claim 1, wherein said base plate and said housing together comprise complementary first and second recesses on multiple sides of said stringer box.

4. The stringer box of claim 1, wherein said base plate includes an upwardly extending rim and said first recess is formed in said upwardly extending rim at said edge of said base plate.

5. The stringer box of claim 1, wherein said second recess is at least partially defined by a cable collar extending from a wall of said housing.

6. The stringer box of claim 5, wherein said cable collar extends inwardly from said wall of said housing.

7. The stringer box of claim 1, wherein said opening is positioned within a distance of said bottom surface substantially equal to said diameter.

8. The stringer box of claim 1, where at least one of a sidewall and a top surface of said housing comprises an electrical outlet receptacle opening.

9. The stringer box of claim 8, wherein said top surface of said housing comprises a movable top plate configured to facilitate access to the interior of said housing.

10. An electrical stringer box comprising:
a housing having contiguous sidewalls;
a cable collar formed adjacent a lower edge of one of said sidewalls, said cable collar defining a first recess formed at said lower edge of said sidewall; and
a base plate carrying a second recess alignable with said first recess, at least one of said first and second recesses carrying features configured to retain an electrical cable inserted into said housing.

11. The stringer box of claim 10, wherein said first and second recesses together define an opening having a diameter, said opening being positioned within a distance of a bottom surface of said base plate substantially equal to twice said diameter.

12. The stringer box of claim 10, wherein said base plate and said housing together comprise complementary first and second recesses on multiple sides of said stringer box.

13. The stringer box of claim 10, wherein said first recess is formed in an upwardly extending rim at a first edge of said base plate.

14. The stringer box of claim 10, wherein said cable collar extends into the interior of said housing.

15. The stringer box of claim 10, where at least one of a sidewall and a top surface of said housing comprises an electrical outlet receptacle opening.

16. The stringer box of claim 15, wherein said top surface of said housing comprises a movable top plate configured to facilitate access to the interior of said housing.

17. A method of forming a variety of stringer box configurations from a common mold, said method comprising:
forming a first stringer box housing configuration having a solid-faced sidewall in an injection mold;
positioning a first outlet opening image insert adjacent a wall of said mold corresponding to said housing sidewall; and
forming a second housing configuration having outlet openings formed in said sidewall of said second housing configuration.

18. The method of claim 17, further comprising positioning at least one of said first image insert and a second image insert adjacent a second wall of said mold; and
forming a third housing configuration having outlet openings formed in a second sidewall of said third housing configuration.

19. The method of claim 18, further comprising:
forming a base plate interchangeably attachable to each of said first and second housing configurations;
forming complementary recesses in said base plate and each of said first and second housing configurations; and
forming projections on one of said complementary recesses to facilitate gripping of an electrical cable to be positioned within said stringer box.

20. A set of varied stringer box configurations producible from a common mold by the method comprising:
forming a first stringer box housing configuration having a solid-faced sidewall in an injection mold;
positioning a first outlet opening image insert adjacent a wall of said mold corresponding to said housing sidewall; and
forming a second housing configuration having outlet openings formed in said sidewall of said second housing configuration.
